(19) United States
(12) Patent Application Publication
(10) Pub. No.: US 2014/0302416 A1
(43) Pub. Date: Oct. 9, 2014

(54) METAL SEPARATOR FOR FUEL CELL AND MANUFACTURING METHOD THEREOF

(71) Applicants: J&L Tech Co., Ltd., Ansan (KR); Hyundai Motor Company, Seoul (KR)

(72) Inventors: Chi-Seung Lee, Yongin (KR); Sae-Hoon Kim, Yongin (KR); Yoo-Chang Yang, Yongin (KR); Byung-Ki Ahn, Yongin (KR); Suk-Min Baeck, Yongin (KR); Young-Mo Goo, Cheonan (KR); Myong-Hwan Kim, Cheonan (KR); Jai-Mo Yoo, Ansan Gyeonggi-Do (KR); Ki-Ho Yeo, Ansan (KR); Seung-Eul Yoo, Cheonan (KR); Young-Ha Jun, Ansan (KR)

(73) Assignees: J&L TECH CO., LTD., Ansan (KR); HYUNDAI MOTOR COMPANY, Seoul (KR)

(21) Appl. No.: 14/043,469

(22) Filed: Oct. 1, 2013

(30) Foreign Application Priority Data
Apr. 9, 2013 (KR) 10-2013-0038799

(51) Int. Cl. H01M 8/02

(52) U.S. Cl. CPC H01M 8/0245
USPC 429/468; 427/577

(57) ABSTRACT

A metal separator for a fuel cell and a manufacturing method thereof are provided, in which a graphite carbon layer with a minute thickness is formed on the surface of a substrate, to improve conductivity. The manufacturing method includes preparing a metal substrate; loading the metal substrate into a chamber with a vacuum atmosphere; coating a graphite carbon layer by depositing carbon ions ionized from a coating source on a surface of the metal substrate; and unloading the metal substrate having the graphite carbon layer coated thereon to an exterior of the chamber.

### CROSS-REFERENCE TO RELATED APPLICATION

This application claims under 35 U.S.C. §119(a) the benefit of Korean Patent Application No. 10-2013-0038799 filed Apr. 9, 2013, the entire contents of which are incorporated herein by reference.

### BACKGROUND

(a) Technical Field

The present disclosure relates to a metal separator for a fuel cell and a manufacturing method thereof. More particularly, the present disclosure relates to a metal separator for a fuel cell and a manufacturing method thereof, in which a graphite carbon layer with a minute thickness is formed on the surface of a substrate, thus improving conductivity.

(b) Background Art

In general, a fuel cell is a power generation device that converts chemical energy into electrical energy, using an oxidation-reduction reaction between hydrogen and oxygen. Since the practicability of a unit cell of the fuel cell is decreased due to low output voltage, the fuel cell is generally used as a fuel cell stack formed by stacking a few to a few hundred of unit cells. When the unit cells are stacked, a separator performs an electrical connection between the unit cells, separates a reaction gas, and operates as a flow path through which cooling water flows.

When a metal separator is used as a representative separator, the reduction in the volume and weight of the fuel cell stack is possible through a decrease in the thickness of the separator, and the fuel cell stack can be manufactured using stamping, thus allowing for mass productivity. The metal separator has high electrical conductivity and improved mechanical characteristic and workability, but the corrosion of the metal separator occurs when the fuel cell is under a substantially high temperature and humidity environment.

The related art provides a method of simultaneously improving conductivity and corrosion resistance by sequentially forming a metal layer for improving conductivity and an oxide layer for reinforcing corrosion resistance on a substrate of a metal separator and then connecting a conductive particle (e.g., graphite) to the metal layer inside the oxide layer, using a film welding method.

However, in the conventional method as described above, conductive particles concentrated with a low density may be separated from a surface of the metal layer. Therefore, conductivity may decrease, and metal exposed to the surface of the metal layer may corrode.

### SUMMARY

The present disclosure provides a metal separator for a fuel cell and a manufacturing method thereof, in which a graphite carbon layer with a minute thickness is formed on the surface of a substrate, thus improving conductivity.

In one aspect, the present disclosure provides a manufacturing method of a metal separator for a fuel cell, including: a first process of preparing a metal substrate; a second process of loading the metal substrate into a chamber with a vacuum atmosphere; a third process of coating a graphite carbon layer by depositing carbon ions ionized from a coating source on a surface of the metal substrate; and a fourth process of unloading the metal substrate having the graphite carbon layer coated thereon to the exterior of the chamber.

In an exemplary embodiment, the vacuum atmosphere in the chamber may be maintained at a temperature of about 200° C. to 1000° C. under a pressure atmosphere of about 10⁻² Torr to 10⁻⁵ Torr.

In another exemplary embodiment, in the third process, the carbon ions may be accelerated by applying, to the surface of the metal substrate, a negative voltage of about −30 V to −1200 V in the form of any one selected from a group consisting of: direct current, alternating current, and pulse frequency.

In still another exemplary embodiment, a thin film deposition method including physical vapor deposition (PVD) or plasma-enhanced chemical vapor deposition (PECVD) may be used in the third process. The graphite carbon layer may be formed to a thickness of about 1 nm to 50 nm.

In yet another exemplary embodiment, the manufacturing method may further include a plasma pre-processing process of forming an argon atmosphere within the chamber prior to the third process.

In another aspect, the present disclosure provides a metal separator for a fuel cell that may include a metal substrate and a fine crystalline graphite carbon layer coated on a surface of the metal substrate, wherein the graphite carbon layer is a separator formed to a thickness of about 1 nm to 50 nm. In an exemplary embodiment, the separator may have a contact resistance of about 15 mΩcm² or less.

According to the present disclosure, only the graphite carbon layer with a substantially thin thickness with a nanoscale may be coated on the surface of the metal substrate, and thus it may be possible to manufacture the metal separator with substantially low contact resistance satisfying surface requirement characteristics of the metal separator for the fuel cell.

### BRIEF DESCRIPTION OF THE DRAWINGS

The above and other features of the present disclosure will now be described in detail with reference to exemplary embodiments thereof illustrated the accompanying drawings which are given hereinbelow by way of illustration only, and thus are not limitative of the present disclosure, and wherein:

FIG. 1 is an exemplary flowchart illustrating a manufacturing method of a metal separator for a fuel cell according to an exemplary embodiment of the present disclosure;

FIG. 2 illustrates an exemplary surface treatment process of the metal separator according to the exemplary embodiment of the present disclosure;

FIG. 3 illustrates an exemplary result obtained by performing Raman analysis on each sample to which a normal-temperature process and a high-temperature process are applied according to an exemplary embodiment of the present disclosure; and

FIG. 4 illustrates an exemplary result obtained by measuring light transmittance when amorphous carbon and graphite carbon are double-coated on slide glasses, respectively according to an exemplary embodiment of the present disclosure.

It should be understood that the accompanying drawings are not necessarily to scale, presenting a somewhat simplified representation of various exemplary features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

The present disclosure provides a surface treatment Of a metal separator for a fuel cell, and particularly, a fine crystalline graphite carbon layer may be formed directly on a surface of the metal separator, to improve electrical conductivity and corrosion resistance.

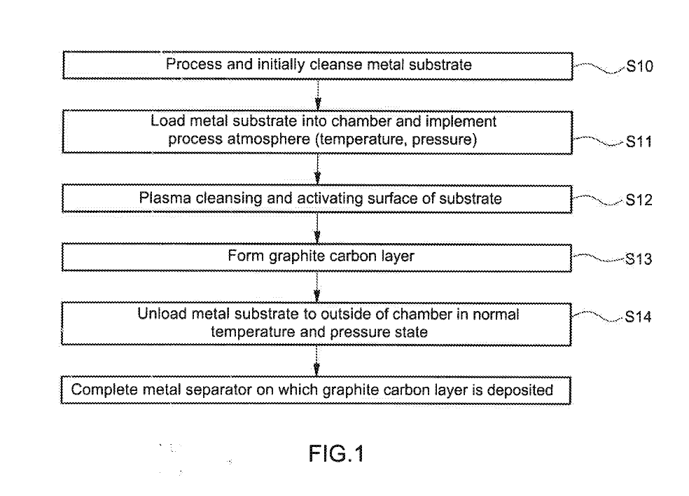

As shown in FIG. 1, in a manufacturing method of a metal separator for a fuel cell according to an exemplary embodiment of the present disclosure, a predetermined metal material used as a substrate of the metal separator may be first processed in the shape of a separator, and initial cleansing may be performed on the processed metal material, to prepare a metal substrate (S10). Stainless steel may be used as the metal material, and ideal stainless steel that is a special alloy as a corrosion-resistance/acid-resistance material may be used as the metal material. Specifically, the metal material may include, for example, SUS 316L, etc.

Further, the metal substrate prepared as described above may be loaded into a chamber with a vacuum atmosphere (or process atmosphere) (S11). The vacuum atmosphere in the chamber may be formed using a vacuum pump, heater, etc. Specifically, the vacuum atmosphere may be formed as a process atmosphere that forms a temperature of about 200° C. to 1000° C. and a pressure of about 10⁻² Torr to 10⁻⁵ Torr. The vacuum atmosphere may be constantly maintained during the manufacturing of the separator by coating a graphite carbon layer coating on a surface of the metal substrate. in other words, the graphite carbon layer may be formed by being deposited on the surface of the metal substrate in an in-situ state in which the coating temperature of about 200° C. to 1000° C. may be maintained under the vacuum state of about 10⁻² Torr to 10⁻⁵Torr.

Subsequently, argon (Ar) ions may be injected into the surface of the metal substrate by forming a plasma field of an Ar atmosphere in the chamber using a plasma source, to cleanse and activate the surface of the metal substrate (S12). In other words, an oxide film or other contaminants may be removed from the surface of the metal substrate through a pre-process using the plasma source, and the surface of the substrate may be activated before the deposition of the carbon layer, to improve the adhesion between the metal substrate and the graphite carbon layer.

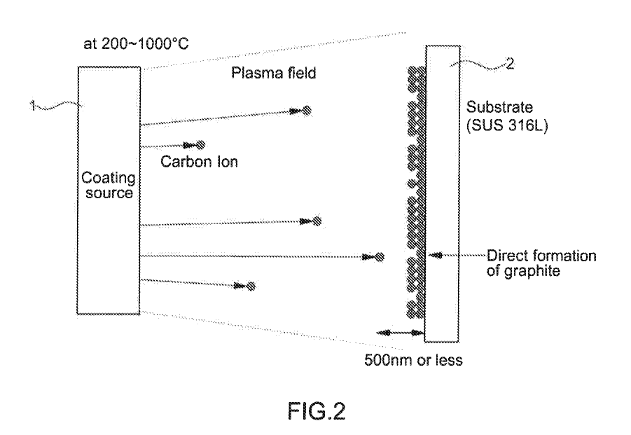

Additionally, as shown in FIG. 2, an ionized coating material may be generated and emitted from a coating source 1 within the chamber, to be deposited on the surface of the metal substrate 2 (S13). The coating material emitted from the coating source I may be coated on the surface of the metal substrate 2 with a discharging power of about 0.1 kW to 5.0 kW, using a thin film deposition method such as physical vapor deposition (PVD) or plasma-enhanced chemical vapor deposition (PECVD), and hydrocarbon (CxHx) gas may be used as the coating source 1. In other words, a plasma field of a carbon atmosphere may be formed within the chamber by generating and emitting carbon ions from a gaseous coating source (or plasma source), and the coating of the metal substrate may be performed with the discharging power of about 0.1 kW to 5.0 kW. In particular, the carbon ions generated from a hydrocarbon coating source may be injected into the surface of the metal substrate to form the graphite carbon layer on the surface of the substrate. The carbon ions may be injected into the surface of the metal substrate, and simultaneously, the graphite carbon layer may be deposited and formed on the surface of the metal substrate.

The hydrocarbon gas may be an amorphous carbon-based material. However, the hydrocarbon gas may be deposited on the metal substrate through an ionization process in the chamber, to coat a fine crystalline graphite carbon layer such as graphite on the surface of the metal substrate. The graphite carbon layer formed on the surface of the metal substrate may be formed to a thin thickness of about 1 nm to 50 nm. When the thickness of the graphite carbon layer is formed to less than about 1 nm, it may be difficult to locally form the graphite carbon layer on the surface of the metal substrate. When the thickness of the graphite carbon layer is formed greater than about 50 nm, the degradation of productivity and economic efficiency may occur.

When the graphite carbon layer is coated on the surface of the metal substrate, the carbon ions injected into the surface of the metal substrate may be accelerated by applying a negative voltage of about −30 V to −1200 V to the surface of the metal substrate to intercept electric charges charged in the metal substrate (e.g., prevent storage of electric charges) and to improve the adhesion between the metal substrate and the carbon layer. In particular, the negative voltage may be applied, to the metal substrate, in the form of any one selected from a group consisting of: direct current, alternating current, and pulse frequency. Specifically, a frequency ranging from about 0.1 kHz to 400 kHz may be used as the pulse frequency.

When a negative voltage of about −30 V or less is applied to the metal substrate, the acceleration of the carbon ions may not be sufficient, and therefore, the adhesion between the graphite carbon layer and the metal substrate may be deteriorated. When a negative voltage greater than about −1200 V is applied to the metal substrate, a local defect may occur in the metal substrate due to collision of excessive carbon ions.

After the graphite carbon layer is formed on the surface of the metal substrate as described above, the metal substrate may be unloaded to the exterior of the chamber under normal temperature (e.g., 25° C.) and pressure conditions (e.g., an ambient pressure or 1 atm) (S14). The metal substrate loaded into the chamber during high temperature (e.g., 450° C.) and high pressure conditions may be unloaded to the exterior of the chamber under the normal temperature and pressure conditions. The metal separator manufactured as described above may have a contact resistance of about 15 mΩcm² or less, thereby improving electrical conductivity. Thus, the metal separator satisfying surface requirement characteristics of the separator for the fuel cell may be manufactured through the process described above.

The contact electric resistance (CER) of the metal separator according to this embodiment was measured, and as a result, it was shown that the CER of the metal separator has a contact resistance of 15 mΩcm² or less at 10 kgf/cm². Conventionally, a deposition thickness of about 500 nm (0.5 μm) was required with respect to the entire coating layer including an intermediate layer when the coating layer is coated on the surface of the metal substrate. However, in the present disclosure, although the coating layer may be formed to a substantially thin thickness of a few nm, it may be possible to implement the characteristic of contact resistance, which may be satisfactorily used as the separator for the fuel cell.

Accordingly, in the present disclosure, the graphite carbon layer may be formed to a substantially thin deposition thickness with a nanoscale, to substantially shorten the process time at which the metal separator is processed to have a low contact resistance (e.g., contact resistance of 15 mΩcm² or less at 10 kgf/cm² or less). In other words, the processes for improving the surface characteristic of the metal separator may be performed in an in-situ state for a substantially short time when the thin deposition thickness with the nanoscale is formed. Accordingly, the graphite carbon layer may be formed in a state in which temperature, vacuum degree and other conditions are equally maintained in all the processes of coating the graphite carbon layer on the surface of the metal substrate.

Further, in the process of depositing carbon ionized from the plasma source (or coating source) on the surface of the metal substrate activated by the plasma pre-process at a process temperature of about 200° C. to 1000° C. under a pressure atmosphere of about 10⁻² Torr to 10⁻⁵ Torr, using a method such as PVD or PECVD, carbon deposition and crystallization may be consecutively performed on the surface of the metal substrate by energy generated from the carbon ions, thermal energy applied from the exterior, electrical energy applied to the metal substrate, etc. Accordingly, the graphite carbon layer may be deposited in the in-situ state.

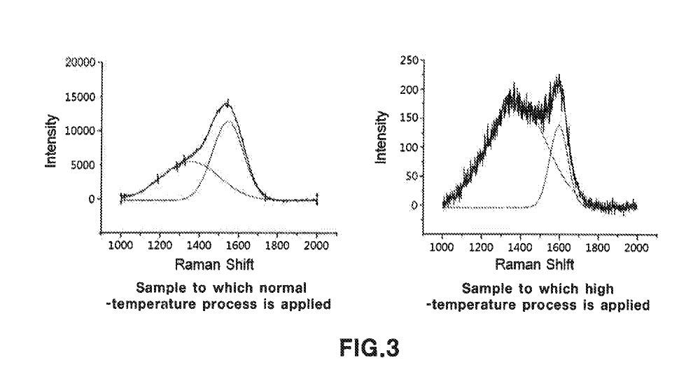

Meanwhile, FIG. 3 shows an exemplary result obtained by preparing a first separator sample on which a carbon thin film on a surface of a metal substrate in a state in which the deposition process temperature is maintained as a normal temperature of about 25° C., preparing a second separator sample on which the carbon thin film is coated on the surface of the metal substrate in a state in which the deposition process temperature is maintained as a high temperature of 450° C., and then performing Raman analysis on each sample. In addition, the other process conditions are similarly set according to the present disclosure.

As shown in FIG. 3, the structure of amorphous carbon (a-C:H) generally known as diamond-like carbon is shown in the first separator sample on which the carbon thin film is deposited at the normal temperature. On the other hand, as shown, the structure similar to that of fine crystalline graphite (μc-graphite) such as graphite is shown in the second separator sample on which the carbon thin film is deposited at the high temperature.

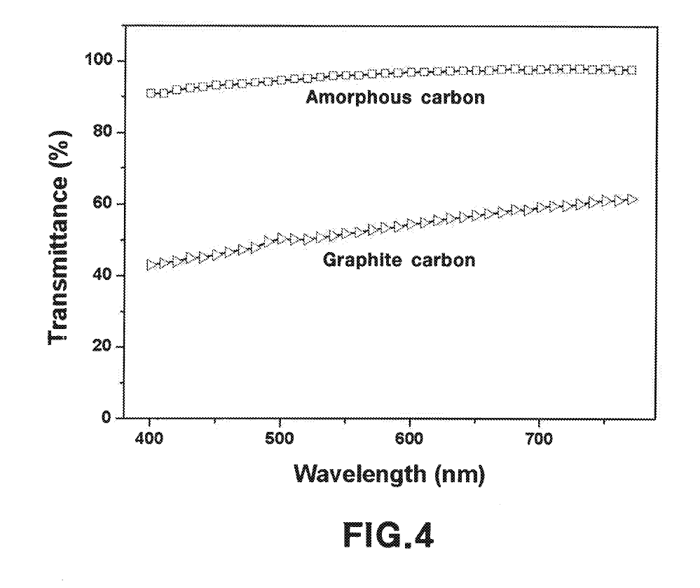

To compare the light transmittance of amorphous carbon layer deposited on the surface of the metal substrate according to the conventional art with the graphite carbon layer deposited on the surface of the metal substrate according to the present disclosure, FIG. 4 shows an exemplary result obtained by respectively depositing amorphous carbon and graphite carbon on both surfaces of slide glass and then measuring light transmittances of the amorphous carbon and the graphite carbon. As shown in FIG. 4, the light transmittance of the graphite carbon is less than that of the amorphous carbon due to the crystallization of a thin film.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A manufacturing method of a metal separator for a fuel cell, comprising:
preparing a metal substrate;
loading the metal substrate into a chamber with a vacuum atmosphere;
coating a graphite carbon layer by depositing carbon ions ionized from a coating source on a surface of the metal substrate; and
unloading the metal substrate having the graphite carbon layer coated thereon to an exterior of the chamber.

2. The manufacturing method of claim 1, wherein the vacuum atmosphere in the chamber is maintained at a temperature of about 200° C. to 1000° C. under a pressure atmosphere of about 10⁻² Torr to 10⁻⁵ Torr.

3. The manufacturing method of claim 1, wherein, in the coating process, the carbon ions are accelerated by applying a negative voltage of about −30 V to −1200 V to the surface of the metal substrate.

4. The manufacturing method of claim 1, wherein, in the coating process, the carbon ions are accelerated by applying a negative voltage to the surface of the metal substrate and the negative voltage is applied in the form of any one selected from a group consisting of direct current, alternating current, and pulse frequency.

5. The manufacturing method of claim 1, wherein a thin film deposition method including physical vapor deposition (PVD) or plasma-enhanced chemical vapor deposition (PECVD) is used in the coating process.

6. The manufacturing method of claim 5, wherein, in the coating process, the carbon ions ionized from the coating source are deposited on the surface of the metal substrate with a discharging power of about 0.1 kW to 5.0 kW.

7. The manufacturing method of claim 1, wherein the graphite carbon layer is formed to a thickness of about 1 nm to 50 nm.

8. The manufacturing method of claim 1, further comprising:
forming an argon atmosphere within the chamber prior to the coating process.

9. The manufacturing method of claim 1, wherein hydrocarbon (CxHx) gas is used as the coating source.

10. A metal separator for a fuel cell comprising:
a metal substrate; and
a fine crystalline graphite carbon layer coated on a surface of the metal substrate,
wherein the graphite carbon layer is a separator formed to a thickness of about 1 nm to 50 nm.

11. The metal separator of claim 10, wherein the separator has a contact resistance of about 15 mΩcm² or less.
